(19) United States
(12) Patent Application Publication
(10) Pub. No.: US 2011/0213611 A1
(43) Pub. Date: Sep. 1, 2011

(54) METHOD AND DEVICE FOR CONTROLLING THE TRANSPORT OF AN OBJECT TO A PREDETERMINED DESTINATION

(75) Inventor: Ingolf Rauh, Reichenau (DE)

(73) Assignee: SIEMENS AKTIENGESELLSCHAFT, MÜNCHEN (DE)

(21) Appl. No.: 13/061,265

(22) PCT Filed: Aug. 28, 2009
(86) PCT No.: PCT/EP09/61108

§ 371 Date: Apr. 29, 2011

(30) Foreign Application Priority Data
Aug. 28, 2008 (DE) 10 2008 044 833.8

(51) Int. Cl. G10L 15/20

(52) U.S. Cl. 704/233; 704/E15.004

(57) ABSTRACT

A method and a device control the transport of an object to a predetermined destination. The object is provided with information on a destination to which the object is to be transported. The destination information with which the object is provided is inputted into a speech detection station. A speech recognition system evaluates the destination information detected by the speech detection station. A conveying device transports the object. The destination, the information of which is provided to the object, is determined. The evaluation result of the speech recognition system is used to determine the destination. A release signal is produced. The release signal triggers two processes: the speech detection station is released for the input of destination information on another object. The conveying device transports the object. The transport of the object to the determined destination is triggered.

The invention relates to a method and a device for controlling the transport of an object to a predetermined destination, in particular a package to a delivery address.

U.S. Pat. No. 6,819,777 B2 describes a method and a device for determining a delivery address on an item of mail and then transporting the item of mail. A computer-accessible image of the item of mail is generated, which image shows the delivery address. A character recognition component (“Optical Character Recognition”, OCR) first of all attempts to automatically read the delivery address. If this is not successful, the image is displayed on a screen. An operator reads the delivery address in the image and inputs it via a keyboard and/or a speech detection station. In one refinement, a plurality of images are displayed on the screen in a temporally overlapping manner.

A device having the features of the precharacterizing clause of claim 1 and a method having the features of the precharacterizing clause of claim 13 are known from WO 2007/135137 A1l. Said document describes a method and a device for automatically determining the delivery address even when this is more difficult than in the case of a standard letter, for example the delivery address of a package. The device comprises
a speech detection station,
a camera (“scanner”),
a speech recognition system (“voice recognition system”),
a character recognition system (“OCR system”), and
a conveying device (“conveyor”).

An operator grasps a package, reads the delivery address on the package, and speaks at least part of the delivery address into the speech detection station. The speech message is converted and transmitted to the speech recognition system. This speech recognition system comprises a database containing valid delivery addresses, for example valid location information, compares the converted speech message with valid delivery addresses in the database and generates a sorted list of candidates with valid delivery addresses. This list is sorted in descending order by the respective “audio score” which is a measure of the match between the converted speech message and the stored delivery address.

The operator places the package onto the conveyor belt after he has spoken the delivery address into the speech detection station. The conveyor belt transports the package to a camera. The latter generates a computer-accessible image of the package. The character recognition system determines the delivery address, for which purpose it evaluates the image and uses the list of candidates from the speech recognition system. In this case, the character recognition system uses a “thresholding method” in order to compare the “audio scores” with credibility measures which assess the credibility of a reading result determined by OCR.

DE 19718805 C2 also describes a method and a device for comparing a list of candidates from a speech recognition system with a second list of candidates from a character recognition system.

The invention is based on the object of providing a device having the features of the precharacterizing clause of claim 1 and a method having the features of the precharacterizing clause of claim 13, which method reduces the risk of incorrectly determining the destination without reducing the throughput of objects through the speech detection station.

The object is achieved by a device having the features of claim 1 and a method having the features of claim 13. Advantageous refinements are specified in the subclaims.

The object is provided with information on a destination to which the object is to be transported. The destination information with which the object is provided is input to a speech detection station. A speech recognition system evaluates the destination information detected by the speech detection station. A conveying device transports the object. The destination with whose information the object is provided is determined. The evaluation result from the speech recognition system is used to determine the destination. A release signal is generated. The release signal initiates the following two operations:
the speech detection station is released in order to input destination information on a further object;
the conveying device transports the object.

The transport of the object to the destination determined is initiated.

According to the solution, the speech recognition system is subdivided into a main speech recognition unit and an additional speech recognition unit. The two speech recognition units evaluate the speech input with the detected destination information independently of one another. The main speech recognition unit can be optimized to the aim of quickly evaluating the destination information and, in particular, quickly recognizing the conclusion of the speech input in order to generate a release signal as quickly as possible and thereby initiate the onward transport of the object. This release signal also enables the speech detection station for the input of further destination information. More computation time is available to the additional speech recognition unit, with the result that the additional speech recognition unit can carry out a more in-depth evaluation with a lower risk of errors.

Since the release signal is generated at an early stage, the situation is avoided in which the speech input must be delayed until the additional speech recognition unit has also concluded its evaluation which is more in-depth and therefore takes longer. Rather, the release signal depends only on the main speech recognition unit which operates more quickly.

The destination is provided on the basis of two evaluations provided by two speech recognition units independently of one another. This reduces the risk of incorrectly determining the destination.

The two speech recognition units can be synchronized with one another in such a manner that they perform their evaluations in overlapping periods of time. It is possible, but not necessary, for one speech recognition unit to wait for the result from the other speech recognition unit.

Since the release signal is generated after the main speech recognition unit has concluded the evaluation and before the speech detection station is released again, the main speech recognition unit does not need to buffer its evaluation result. Rather, a further speech input to be evaluated by the main speech recognition unit is carried out only after the release signal.

The evaluation result from the main speech recognition unit can be transmitted to the additional speech recognition unit or to a central recognition unit, for example a “voting system”, as soon as the conveying device begins to transport the object. Since the transport speed of the conveying device is generally known, this refinement facilitates synchronization and the association between the object and the evaluation result from the main speech recognition unit, which result relates to said object. This advantage is particularly important when a large number of objects need to be transported, for example a sequence of packages.

The conveying device preferably transports the object to a further processing station. The conveying device typically requires at least several seconds to transport the object to this processing station.

This transport time is available to the additional speech recognition unit in order to evaluate the speech input containing the destination information on the object. The evaluation result from the additional speech recognition unit only needs to be available when the object has reached the further processing station. As soon as the result from the additional speech recognition unit is available, the further processing station can use this result to process the object.

Since the conveying device transports the object only when the main speech recognition unit has concluded its evaluation, it is possible for the location to which the conveying device transports the object to be made dependent on that evaluation result which is provided by the main speech recognition unit. This makes it possible, for example, for the conveying device to transport the object to a first intermediate point which has already been recognized by the main speech recognition unit. As soon as the object reaches the first intermediate point, the result from the additional speech recognition unit is available, which enables onward transport or further sorting of the object.

The main speech recognition unit preferably operates according to fixed timing. Speech input is concluded by an input signal or the end of speech input is automatically recognized. The speech detection station is released again at the latest at a predetermined time limit after the input signal has been generated. It is not necessary to buffer the speech message.

The main speech recognition unit preferably automatically recognizes when the input of destination information on an object has been concluded, for example by the speaker pausing for a sufficiently long time. Only the additional speech recognition unit evaluates this speech input containing the destination information. This makes it possible to clock the main speech recognition unit with a short clock time.

The additional speech recognition unit preferably comprises a plurality of individual speech recognition units which operate in a parallel manner. Each individual speech recognition unit respectively evaluates a speech input, to be precise preferably after the main speech recognition unit has evaluated this speech input and the release signal has been generated. This makes it possible for the additional speech recognition unit to evaluate a plurality of speech inputs in a temporally overlapping manner, which saves time in comparison with serial processing. In the period of time in which the additional speech recognition unit evaluates a speech input, it is possible to input destination information on a plurality of further objects and to have said information processed by the main speech recognition unit.

In one preferred refinement, the detected destination information is transmitted from the speech detection station only to the main speech recognition unit, but not from the speech detection station directly to the additional speech recognition unit. The main speech recognition unit transmits its own evaluation result to the additional speech recognition unit. For example, the main speech recognition unit recognizes when a speech input relating to an object has been completed and removes interfering noise from this speech input. This refinement facilitates synchronization between the two speech recognition units. It also dispenses with the need for the speech detection station to buffer the detected destination information.

Two arrangements in which the method according to the solution can be used are described below. The first arrangement determines the destination only using the speech input evaluated by the two speech recognition units. The second arrangement additionally evaluates an image of the object in order to optically recognize the destination.

If the method according to the solution is used in the first arrangement, the use of the two speech recognition units dispenses with an image recording device and a character recognition system. This refinement can be used, for example, for conveying luggage inside an airport or port or for the flow of material inside a factory. The object is first of all transported into a region, for example an intermediate point which is responsible for a plurality of destinations.

The evaluation result from the main speech recognition unit is already available when the release signal is generated and the conveying device begins to transport the object. As a result, the evaluation result from the main speech recognition unit can be used to automatically decide, at the start of transport, where the conveying device transports the object to. For example, a decision is made as to which of a plurality of possible intermediate points the object is transported to. Only the evaluation result from the main speech recognition unit is used for this purpose.

When the object has reached the intermediate point, the evaluation result from the additional speech recognition unit is available. The object is then transported from the respective intermediate point to a destination. The evaluation result from the additional speech recognition unit is used to decide which destination this object is transported to or to transport the object to another intermediate point if it is determined that the main speech recognition unit has recognized an incorrect intermediate point.

In the second arrangement, an image of the object is additionally used to recognize the destination. The conveying device transports the object to an image recording device. This image recording device generates an optical image of the object. A character recognition system evaluates the image. The evaluation result from the character recognition system is additionally used to determine the destination.

Thanks to this refinement, the evaluation result from the speech recognition system is already available when the character recognition system begins its evaluation. It is possible for the character recognition system to use this speech input evaluation result. For example, the character recognition system selects an address database containing valid destinations on the basis of this evaluation result.

The method according to the solution can be used, in particular, when it is necessary to transport objects whose destinations cannot be detected in an optical manner alone because the objects are too large and/or because the destination information can be automatically detected only with difficulty. These objects are, for example, items of luggage belonging to travelers, transport containers, workpieces in a production system or else packets containing drugs. Since a worker transfers the object, he needs both hands and cannot make any inputs with a keyboard. Therefore, only speech input remains.

The invention is described below using an exemplary embodiment. In the drawing:

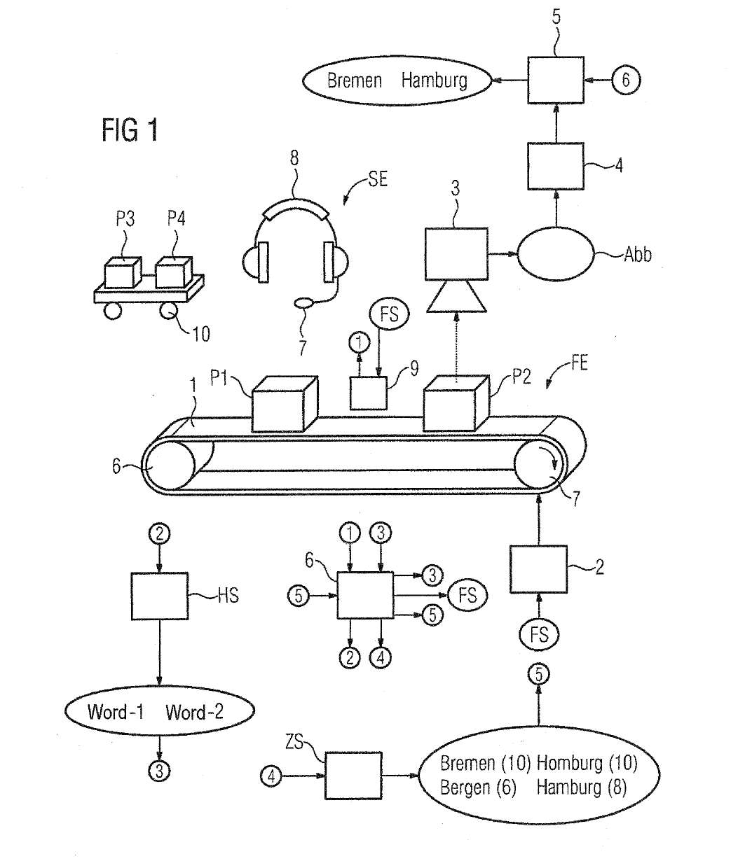

FIG. 1 schematically shows the arrangement which recognizes addresses on postal packages;

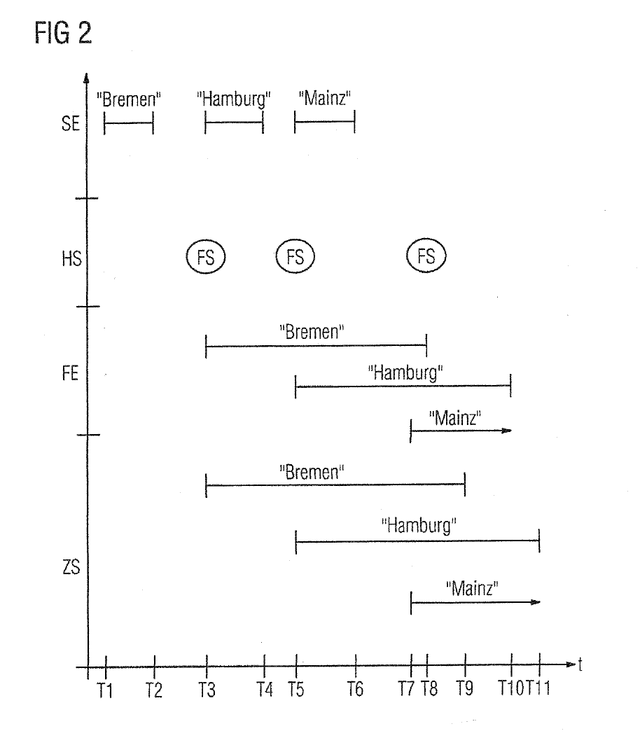

FIG. 2 shows the temporal profile when recognizing addresses.

In the exemplary embodiment, the method according to the solution is used to sort packages. Each package is provided with information on the respective delivery address to which the package is to be transported.

FIG. 1 shows an arrangement which implements the method. This arrangement comprises the following parts:
a speech detection station SE,
a main speech recognition unit HS,
an additional speech recognition unit ZS,
a conveying device FE with a driven conveyor belt 1 and a drive 2 for the conveyor belt 1,
an image recording device which comprises at least one camera 3,
a character recognition system (“optical character recognition system”) 4,
a central recognition unit 5 in the form of a “voting system”, and
a transmission and synchronization unit 6.

The transmission and synchronization unit 6 synchronizes the processing steps described below. The speech detection station SE comprises a microphone 7. It is possible for this microphone 7 to be fitted in a stationary manner. However, a worker preferably wears this microphone 7 on his head as part of a headset. The microphone 7 is preferably in the form of a cordless device and transmits its results to a stationary receiver 9, for example by radio or infrared or using a mobile radio transmission protocol.

In one refinement, the speech detection station SE additionally comprises a headset 8. This headset 8 is used to audibly inform the worker of the release signal FS, with the result that the worker can then make a further speech input to the speech detection station SE.

The worker takes a package from a supply device or from a container or a pallet or a non-driven carriage 10. In the example shown in FIG. 1, two packages P3, P4 are still on a non-driven carriage 10.

The worker looks for the delivery address on the package, reads all or at least part of this delivery address and speaks the information which has been read into the microphone 7. For example, he speaks either the country or the city. This information suffices to transport the package. In the example shown in FIG. 1 and FIG. 2, he speaks only the location if the delivery address is national or the country if the delivery address is abroad.

In one embodiment, this speech input is concluded by an input signal. It is possible for the worker to operate a button when he has concluded the speech input for a delivery address. The speech input can also be simply concluded by the worker pausing for a time which is longer than a predetermined pause limit and the speech detection station thus automatically recognizing that the input has been concluded. It is also possible for the end of the speech input to be recognized by the worker placing the package onto the conveyor belt and this being recognized by a light barrier.

However, in one preferred embodiment, the main speech recognition unit HS automatically recognizes that the input of the destination information on the object has been concluded. The worker therefore does not need to indicate the completion of the speech input or to “inform” the arrangement in another manner. The main speech recognition unit HS recognizes that the speaker has paused for a time which is longer than the predetermined pause limit. In the example shown in FIG. 1, the main speech recognition unit first of all recognizes when the input of the word “word-1” has been concluded and then when the input of the word “word-2” has been concluded.

The speech detection station SE converts each detected speech input containing information on the delivery address into a sequence of electrical signals. The transmission and synchronization unit 6 transmits this sequence from the speech detection station SE to the main speech recognition unit HS. This main speech recognition unit HS preferably automatically recognizes when the worker has concluded the input of the delivery address information on a package.

In all embodiments, the worker places the package onto the conveyor belt 1 after the speech input has been concluded. The worker places the package onto the conveyor belt 1 in such a manner that the delivery address can be seen on the upwardly facing side of the package. In the example shown in FIG. 1, the worker places the package P1 onto the conveyor belt 1 after he has read part of its delivery address.

The arrangement generates a release signal FS. This release signal FS initiates the following two operations:
the speech detection station SE is released for the speech input of destination information on a further package P3;
the drive 2 moves the conveyor belt 1 and the driven conveyor belt 1 transports the package P1.

In one refinement, the conveyor belt 1 transports the package P1 over a predefined distance and then stops. In another refinement, the drive 2 permanently rotates the conveyor belt 1. A light barrier or a weight sensor monitors the conveyor belt 1 and determines when the worker has placed the package 1 onto the conveyor belt. The release signal FS is generated as soon as the main speech recognition unit HS has concluded its evaluation for the package P1 and the package P1 has been placed onto the conveyor belt 1.

The worker removes a further package P3 from the supply device or the container or the pallet or the carriage 10. He reads the further delivery address with which this further package P3 is provided and inputs all or at least part of this further delivery address to the speech detection station SE which has now been released again.

The conveyor belt 1 transports the package P2 to the image recording device with the camera 3. The at least one camera 3 generates a computer-accessible image Abb of that side of the package which shows the delivery address. It is also possible for a plurality of cameras to produce images of different sides of the package P2 in order to ensure that one image shows the delivery address of the package P2.

In the exemplary embodiment, the main speech recognition unit HS operates in a serial manner. In contrast, the additional speech recognition unit comprises a plurality of individual speech recognition units which operate in a temporally overlapping manner.

A time limit is predetermined for the work of the main speech recognition unit HS, for example one second. The main speech recognition unit HS operates with real-time capability and is configured to recognize the completion of the speech input for a package within this time limit and to pre-process the detected and converted delivery address information for the additional speech recognition unit ZS. The period of time available to the main speech recognition unit HS begins as soon as the worker pauses during speech input for a time which is longer than the predetermined pause limit and ends at the latest when the predetermined time limit of, for example, one second has elapsed. The main speech recognition unit HS generates an evaluation result within this period of time. It provides the transmission and synchronization unit 6 with the following two results:
the converted detected delivery address information and
the evaluation result from the main speech recognition unit HS.

There is no need for the main speech recognition unit HS to buffer these two results.

In the exemplary embodiment, the main speech recognition unit HS recognizes when the speech input for a package has been concluded and removes interfering noise and speech inputs which obviously do not belong to the destination, for example the speaker clearing his throat or coughing, from the converted detected delivery address information. The main speech recognition unit HS thus provides an adjusted speech input for the delivery address. The main speech recognition unit HS does not carry out any further evaluations. In particular, the main speech recognition unit HS does not recognize the delivery address.

After the main speech recognition unit HS has delivered this adjusted speech input, the transmission and synchronization unit 6 generates the release signal FS. The speech detection station SE is then available for inputting further destination inputs and the conveyor belt 1 transports the package to the image capture device 3.

The transmission and synchronization unit 6 transmits the adjusted speech input provided by the main speech recognition unit HS to the additional speech recognition unit ZS. The additional speech recognition unit ZS selects one of its individual speech recognition units which is currently not evaluating destination information detected at an earlier point in time and is therefore “free”. If no individual speech recognition unit is currently available, the additional speech recognition unit ZS buffers the converted destination information as well as the evaluation result from the main speech recognition unit HS (the adjusted speech input for the destination information) until an individual speech recognition unit is free.

In the exemplary embodiment, the conveyor belt 1 transports the packages at a constant speed. It is therefore definite how much time is available between
the time at which the main speech recognition unit HS provided the adjusted speech input for a package and the release signal FS was generated and
the time at which the image recording device 3 generated the computer-accessible image of this package.

The package has reached the image recording device 3 between these two times. The period of time between these two times is available to the additional speech recognition unit ZS.

The selected individual speech recognition unit evaluates the adjusted speech inputs provided by the main speech recognition unit HS and recognizes the spoken information on the delivery address. The additional speech recognition unit ZS generally cannot clearly recognize the spoken delivery address information, but rather provides a list of candidates. In the exemplary embodiment, each candidate is a possible destination, for example a national city or a country. For each candidate, the additional speech recognition unit ZS additionally calculates a certainty measure (credibility measure) as an assessment of how well the respective candidate matches the adjusted speech input.

In the example shown in FIG. 1, the additional speech recognition unit ZS provides the two possible results “Bremen” with a certainty measure of 10 and “Bergen” with a certainty measure of 6 for the first word. For the second word, the additional speech recognition unit ZS provides the two possible results “Homburg” with a certainty measure of 10 and “Hamburg” with a certainty measure of 8.

As already explained, the image recording device 3 provides at least one computer-accessible image Abb of the package P2, which image shows the delivery address on the package P2. This image is transmitted to the character recognition system 4. The character recognition system 4 recognizes where the delivery address is shown (determination of the “region of interest”) in the image Abb and reads the delivery address by evaluating the image Abb. The character recognition system 4 generally also cannot clearly read the address, but rather likewise provides a list of candidates. For each candidate, the character recognition system 4 additionally calculates a certainty measure (credibility measure) as an assessment of how well the respective candidate matches the image.

In that refinement which is shown in FIG. 1, the additional speech recognition unit ZS and the character recognition system 4 operate independently of one another. In this refinement,
that list of candidates which is provided by the additional speech recognition unit ZS and
that list of candidates which is provided by the character recognition system 4

are transmitted to the central recognition unit (“voting system”) 5. This recognition unit 5 compares the candidates in the lists and the certainty measures and generates an overall assessment. For example, the recognition unit 5 uses a method known from WO 2007/135137 A1.

In another refinement, the evaluation result from the additional speech recognition unit ZS is transmitted to the character recognition system 4. The character recognition system 4 uses this evaluation result in its evaluation, for example in order to restrict the search space.

FIG. 2 shows the temporal profile when recognizing addresses. Time is plotted on the x axis, and the different processing units, namely the speech detection station SE, the main speech recognition unit HS, the conveying device FE and the additional speech recognition unit ZS, are illustrated on the y axis.

In the example shown in FIG. 2, three packages are processed. The first package needs to be transported to Bremen, the second package needs to be transported to Hamburg and the third package needs to be transported to Mainz.

The worker first of all inputs the word “Bremen”, then the word “Hamburg” and then the word “Mainz” to the speech detection station SE. As the delivery address, the worker inputs only the name of the respective location to which the package needs to be transported. The input of the word “Bremen” takes up the period of time between the times T1 and T2, the input of the word “Hamburg” takes up the period of time between the times T3 and T4 and the input of the word “Mainz” takes up the period of time between the times T5 and T6.

The main speech recognition unit HS recognizes when the input of a delivery address to the speech detection station SE has been concluded. In the example shown in FIG. 2, the main speech recognition unit HS recognizes, at the time T3, that the input of the word “Bremen” has been concluded and generates the release signal FS. At the time T5, the main speech recognition unit HS recognizes that the input of the word “Hamburg” has been concluded and, at the time T7, recognizes that the input of the word “Mainz” has been concluded. At the times T5 and T7, the main speech recognition unit HS likewise generates the release signal FS.

The generation of the release signal FS at the time T3 moves the conveyor belt of the conveying device FE. Between the times T3 and T8, the conveyor belt transports the package with the delivery address in Bremen to the camera. Between the times T5 and T10, the conveyor belt transports the package with the delivery address in Hamburg to the camera. From the time T7 on, the conveyor belt transports the package with the delivery address in Mainz to the camera.

Between the times T8 and T9, the camera generates a computer-accessible image Abb of the package with the delivery address in Bremen. Between the times T10 and T11, the camera generates a computer-accessible image of the package with the delivery address in Hamburg.

The two periods of time in which the package to Bremen is transported to the camera and the camera generates the image Abb of this package are available to the additional speech recognition unit ZS in order to evaluate the speech input “Bremen”. These two periods of time result overall in the period of time between the two times T3 and T9. In a corresponding manner, the period of time between the times T5 and T11 is available to the additional speech recognition unit ZS in order to evaluate the speech input “Hamburg” and the period of time from the time T7 on is available to the additional speech recognition unit ZS in order to evaluate the speech input “Mainz”.

### LIST OF REFERENCE SYMBOLS

| Reference symbol | Meaning |
|---|---|
| 1 | Driven conveyor belt |
| 2 | Drive for the conveyor belt 1 |
| 3 | Camera of the image recording device |
| 4 | Character recognition system |
| 5 | Central recognition unit |
| 6 | Transmission and synchronization unit |
| 7 | Microphone of the speech detection station |
| | SE |
| 8 | Headset of the speech detection station SE |
| 9 | Stationary receiver of the speech |
| | detection station SE |
| 10 | Non-driven carriage with the two packages |
| | P3, P4 |
| Abb | Computer-accessible image of the package |
| | P2 |
| FE | Conveying device with conveyor belt 1 and |
| | drive 2 |
| FS | Release signal |
| HS | Main speech recognition unit |
| P1 | Package which is on the conveyor belt 1 |
| | and the delivery address of which has just |
| | been input to the speech detection station |
| | SE |
| P2 | Package which is under the camera 3 and |
| | from which the image Abb is generated |
| P3, P4 | Packages on the non-driven carriage 10 |
| SE | Speech detection station |
| T1 | Time at which speech input of the word |
| | “Bremen” begins |
| T2 | Time at which speech input of the word |
| | “Bremen” ends |
| T3 | Time at which speech input of the word |
| | “Hamburg” begins, and likewise time at |
| | which the main speech recognition unit HS |
| | recognizes that input of the word “Bremen” |
| | has been concluded and the release signal |
| | FS is generated, and likewise time at |
| | which the additional speech recognition |
| | unit starts to evaluate the word “Bremen” |
| T4 | Time at which speech input of the word |
| | “Hamburg” ends |
| T5 | Time at which speech input of the word |
| | “Mainz” begins, and likewise time at which |
| | the main speech recognition unit HS |
| | recognizes that input of the word |
| | “Hamburg” has been concluded and the |
| | release signal FS is generated, and |
| | likewise time at which the additional |
| | speech recognition unit starts to evaluate |
| | the word “Hamburg” |
| T6 | Time at which speech input of the word |
| | “Mainz” ends |
| T7 | Time at which the main speech recognition |
| | unit HS recognizes that input of the word |
| | “Mainz” has been concluded and the release |
| | signal FS is generated, and likewise time |
| | at which the additional speech recognition |
| | unit starts to evaluate the word “Mainz” |
| T8 | Time at which the package to Bremen |
| | reaches the camera |
| T9 | Time at which the camera has generated an |
| | image of the package to Bremen, and |
| | likewise time at which the additional |
| | speech recognition unit has recognized the |
| | word “Bremen” |
| T10 | Time at which the package to Hamburg |
| | reaches the camera |
| T11 | Time at which the camera has generated an |
| | image of the package to Hamburg, and |
| | likewise time at which the additional |
| | speech recognition unit has recognized the |
| | word “Hamburg” |
| ZS | Additional speech recognition unit |

1-13. (canceled)

14. A method for controlling transporting of an object, the object is provided with destination information on a destination to which the object is to be transported, which comprises the steps of:
inputting, at least partially, into a speech detection station the destination information with which the object is provided;
evaluating, via a speech recognition system, speech input detected by the speech detection station;
determining a destination based on an evaluation result from the speech recognition system, the speech recognition system having a main speech recognition unit and an additional speech recognition unit, both of the speech recognition units evaluate a detected speech input, evaluation results from both the main and additional speech recognition units are used to determine the destination;
generating a release signal after the main speech recognition unit has concluded an evaluation of the detected speech input, the release signal initiating the following two operations:
releasing the speech detection station for receiving an input of destination information on a further object; and
transporting the object on a conveying device and initiating transport of the object to the destination determined.

15. The method according to claim 14, wherein the additional speech recognition unit starts to evaluate the detected speech input after the release signal has been generated.

16. The method according to claim 14, which further comprises:
during a processing of the detected speech input by the main speech recognition unit, automatically recognizing, via the main speech recognition unit, when the input of the destination information to the speech detection station has been completed;
generating the release signal after the main speech recognition unit has recognized the completion; and
transmitting the evaluation result from the main speech recognition unit to the additional speech recognition unit.

17. The method according to claim 14, which further comprises:
providing an upper time threshold for a period available to the main speech recognition unit for evaluating the detected speech input; and
generating the release signal in such a manner that at most the upper time threshold elapses between a time at which the input of the destination information has been completed and a time at which the main speech recognition unit has completed its evaluation of the detected speech input.

18. The method according to claim 14, wherein:
the conveying device transports the object to a processing device;
the processing device processes the object; and
the additional speech recognition unit concludes its evaluation of the detected speech input at a latest when the object reaches the processing device.

19. The method according to claim 18, which further comprises transmitting, an evaluation result which was generated by the additional speech recognition unit by processing the detected speech input, to the processing device, and the processing device uses the evaluation result to process the object.

20. The method according to claim 18, wherein:
the processing device has an image recording device and a character recognition system;
the image recording device generates an optical image of the object;
the character recognition system evaluates the image; and
the character recognition system uses the evaluation result from the additional speech recognition unit for the evaluation of the image.

21. The method according to claim 14, which further comprises:
automatically recognizing that the object has been placed onto the conveying device; and
generating the release signal after the main speech recognition unit has concluded its evaluation and the placing of the object was recognized.

22. The method according to claim 14, which further comprises:
transmitting the evaluation result from the main speech recognition unit to the additional speech recognition unit; and
generating the release signal after the transmission has been concluded.

23. The method according to claim 14, which further comprises:
transmitting the detected speech input to the additional speech recognition unit; and
generating the release signal only after the transmission of the detected speech input to the additional speech recognition unit has been concluded.

24. The method according to claim 23, wherein the generation of the release signal is initiated by the fact that the main speech recognition unit has concluded the evaluation of the detected speech input as well as the transmission of the detected speech input to the additional speech recognition unit has been concluded.

25. The method according to claim 14, wherein:
after the release signal has been generated, further destination information with which a further object is provided is input to the speech detection station;
both speech recognition units evaluate the further detected speech input;
the release signal is generated again after the main speech recognition unit has concluded the evaluation of the further speech input;
the renewed generation of the release signal initiates the operation of the conveying device transporting the further object; and
the additional speech recognition unit starts to evaluate the further detected speech input before the additional speech recognition unit has concluded the evaluation of the detected speech input.

26. A device for controlling transport of an object, the object is provided with destination information on a destination to which the object is to be transported, the device comprising:
a speech detection station detecting the destination information with which the object is provided and which is at least partially input into said speech detection station;
a speech recognition system for evaluating speech input detected by said speech detection station, said speech recognition system having a main speech recognition unit and an additional speech recognition unit, the device configured to use evaluation results from both said main speech recognition unit and said additional speech recognition unit to determine the destination, both said main speech recognition unit and said additional speech recognition unit configured to evaluate the detected speech input;
a central determination unit;
a conveying device for transporting the object;
a synchronization unit configured to generate a release signal after said main speech recognition unit conclude the evaluation of the detected speech input, and said synchronization unit configured to synchronize said speech detection station and said conveying device such that the release signal initiates the two operations of said speech detection station being released for the input of further destination information on a further object and said conveying device transporting the object; and
the device configured to initiate transport of the object to the destination determined.
